(19) United States
(12) Patent Application Publication
(10) Pub. No.: US 2017/0017711 A1
(43) Pub. Date: Jan. 19, 2017

(54) INFORMATION ASSET MANAGEMENT SYSTEM AND INFORMATION ASSET MANAGEMENT METHOD

(71) Applicant: Hitachi, Ltd., Tokyo (JP)

(72) Inventors: Shinichirou HANAWA, Tokyo (JP); Akira KAMEI, Tokyo (JP); Ryuji NII, Tokyo (JP); Ryouji KUGITA, Tokyo (JP); Sayo HORITA, Tokyo (JP)

(21) Appl. No.: 15/140,602

(22) Filed: Apr. 28, 2016

(30) Foreign Application Priority Data
Jul. 15, 2015 (JP) 2015-140976

(51) Int. Cl. G06F 17/30; H04L 29/08

(52) U.S. Cl. CPC G06F 17/30598; H04L 67/10

(57) ABSTRACT

An object of the present invention is to perform a development work of an information asset with high efficiency. Provided is an information asset management system including a processor that executes a program, and a memory, and generating a new information asset based on a specified information asset. The information asset management system includes: an asset association storage part that stores therein asset association information obtained by associating the information asset with a process of generating a new information asset from the information asset and managing the new information asset; a process identification part that identifies the process to be executed for the specified information asset based on the asset association information; and an asset generation part that generates the new information asset from the specified information asset based on the identified process.

### CROSS-REFERENCE TO RELATED APPLICATIONS

The present application claims a priority from Japanese Patent Application No. 2015-140976 filed on Jul. 15, 2015, the content of which is herein incorporated by reference.

### BACKGROUND OF THE INVENTION

1. Field of the Invention

The present invention relates to an information asset management system, and an information asset management method.

2. Related Art

A large number of methods of managing information assets such as a software asset have been conventionally proposed. For example, Japanese Patent Application Laid-open Publication No. 2011-237898, hereinafter Patent Document 1, discloses a technique in which: an asset information collection server periodically collects terminal-specific information from each user terminal, and stores the terminal-specific information in association with a collection date/time; and an asset management server refers to the collection date/time in the asset information collection server based on the terminal-specific information on a terminal specified as an inventory target, stores the collection date/time as an existence confirmation date, extracts a mail address from user information of each terminal unmatched with a specified inventory period, transmits a follow-up mail stating that the terminal is not inventoried yet, and outputs a file containing an inventory result based on the user information, terminal information, existence confirmation date of the terminal specified as the inventory target.

Japanese Patent Application Laid-open Publication No. 2001-290937, hereinafter Patent Document 2, discloses a technique in which: an asset management client collects asset management information such as a destination MAC address or a transmission source MAC address and a destination IP addressor a transmission source IP address from a header part of information distributed through a network and delivers this information to an asset management server; and this asset management server compares the collected management information with registered contents of an asset management ledger master, and updates the registered contents by using the collected management information if the collected management information and the registered contents do not match with each other as the comparison result because of transfer of an asset to another department or the like, for example.

Japanese Patent Application Laid-open Publication No. 2006-202239, hereinafter Patent Document 3, discloses a technique in which an asset management system includes: a server provided with a management control part and a database including an asset table in which a plurality of records with identifiers and various attribute information of assets are stored, and a movement history table in which at least histories of movements such as incomings and outgoings of the assets are described; a communication line coupled to the server; and a plurality of terminals for display and input, which are coupled to the server through the communication line. The movement history table includes a management section of each asset, as an item of a record forming the table, in addition to an identifier of the asset, a keeping section of movement source, a movement date, and a keeping section of movement destination.

### SUMMARY OF THE INVENTION

Patent Document 1 relates to automations of the inventory by an existence confirmation of a computer asset, and the follow-up of a user of an asset not inventoried yet since its existence has not been confirmed, and is targeted for an inventory work in the asset management. Patent Document 2 also relates to an automation of a system for making an inventory for asset management verification and an automation of a management method in a large-scaled LAN management, and is targeted for an inventory work. Moreover, Patent Document 3 relates to a management of movements and locations of assets distributedly disposed in a plurality of sections of an organization.

In a management of an information asset such as software, a management of an asset development such as a production of a load module (execution module) from a program (source code) is especially important. The management in this case needs to involve various managements such as a management of correction and version of the source code, and a management of a distribution destination of the load module. However, the above-mentioned disclosed techniques do not cover these managements, so that a manual operation and an operation with human intervention are necessary, and a person such as a developer who is not familiar with the asset management needs to confirm the asset management from a manual or the like, and has a high risk of performing an erroneous management and operation.

The present invention is made in view of such circumstances, and aims to provide an information asset management system and an information asset management method for performing a development work of an information asset with high efficiency.

In order to solve the above-described and other problems, an aspect of the present invention provides an information asset management system including a processor that executes a program, and a memory, and generating a new information asset based on a specified information asset. The information asset management system includes: an asset association storage part that stores therein asset association information obtained by associating the information asset with a process of generating a new information asset from the information asset and managing the new information asset; a process identification part that identifies the process to be executed for the specified information asset based on the asset association information; and an asset generation part that generates the new information asset from the specified information asset based on the identified process.

According to the present invention, a development work of an information asset can be performed with high efficiency.

### BRIEF DESCRIPTION OF THE DRAWINGS

FIG. 1 is a diagram describing an entire configuration of an information asset management system, which is described as the present embodiment;

FIG. 2 is a diagram describing an example of a hardware configuration of an asset management apparatus 10;

FIG. 3 is a diagram describing an example of functions that the asset management apparatus 10 includes, and storage regions that the asset management apparatus 10 has;

FIG. 4 is a table describing an example of asset association information 122;

FIG. 5 is a diagram describing an example of functions that a developer apparatus 20 includes;

FIG. 6 is a diagram describing an example of functions that an asset development apparatus 30 includes;

FIG. 7 is a diagram describing an example of a function that an execution apparatus 40 includes;

FIG. 8 is a flowchart describing a detail of an asset managing process SO;

FIG. 9 is a flowchart describing a detail of an asset specifying process S1;

FIG. 10 is a diagram describing an example of a configuration of development requirement information 121;

FIG. 11 is a flowchart describing a detail of an asset editing process S3;

FIG. 12 is a diagram illustrating an example of environment information 123;

FIG. 13 is a flowchart describing a detail of an asset developing process S5;

FIG. 14 is a flowchart describing a detail of an asset registering process S7;

FIG. 15 is a flowchart describing a detail of an asset distributing process S9;

FIG. 16 is a diagram illustrating an example of a screen that is outputted from an asset transition output part 214; and

FIG. 17 is a diagram illustrating an example of another screen that is outputted from the asset transition output part 214.

### DETAILED DESCRIPTION OF THE INVENTION

Hereinafter, detailed descriptions will be given of an embodiment of the present invention by use of the accompanying drawings.

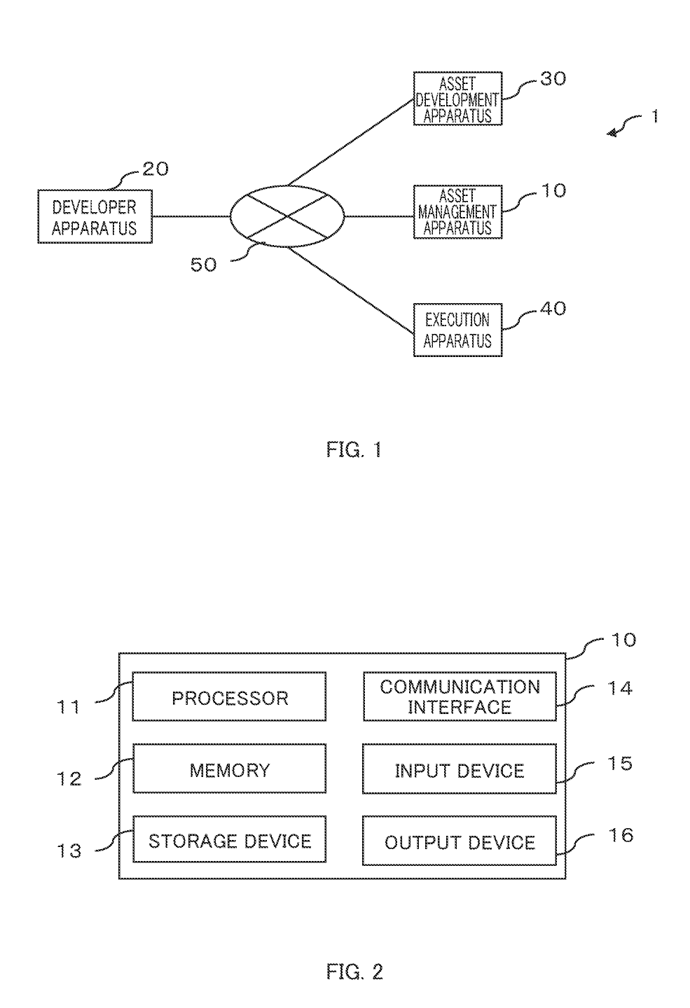

FIG. 1 is a diagram describing an entire configuration of an information asset management system according to the present embodiment. As illustrated in FIG. 1, an information asset management system 1 is configured to include an asset management apparatus 10, a developer apparatus 20, an asset development apparatus 30, and an execution apparatus 40. The asset management apparatus 10 is an information processing apparatus (computer) that stores and manages information assets such as source code of a program, and a new information asset (hereinafter, referred to as a generation asset) such as a load module (for example, an object code generated by the source code being compiled, and an execution file (load module)) that is generated from these information assets. The developer apparatus 20 is an information processing apparatus that is used by a developer who develops the generation asset, a person in charge of distribution of the developed generation asset, and other persons (hereinafter, referred to as a developer or others). The asset development apparatus 30 is an information processing apparatus that generates a generation asset. The execution apparatus 40 is an information processing apparatus that executes the generation asset generated by the asset development apparatus 30. The asset management apparatus 10, the developer apparatus 20, the asset development apparatus 30, and the execution apparatus 40 are coupled to one another in a communicable manner via a communication network 50 such as a local area network (LAN), a wide area network (WAN), a lease line, or the Internet, for example.

FIG. 2 is a diagram describing an example of a hardware configuration of the asset management apparatus 10. As illustrated in FIG. 2, the asset management apparatus 10 is provided with a processor 11 such as a central processing unit (CPU) or a micro processing unit (MPU), a memory 12 (a volatile memory such as a RAM or a non-volatile memory such as a ROM or an NVRAM), a storage device 13 such as a hard disk or a solid state drive (SSD), a communication interface 14 that communicates with other information processing apparatuses (the developer apparatus 20, the asset development apparatus 30, and the execution apparatus 40), an input device 15 such as a key board, a touch panel, or an operation button, and an output device 16 such as a liquid crystal display.

It should be noted that the other information processing apparatuses (the developer apparatus 20, the asset development apparatus 30, and the execution apparatus 40) are also provided with the hardware configurations similar to that of the asset management apparatus 10, although which are not illustrated.

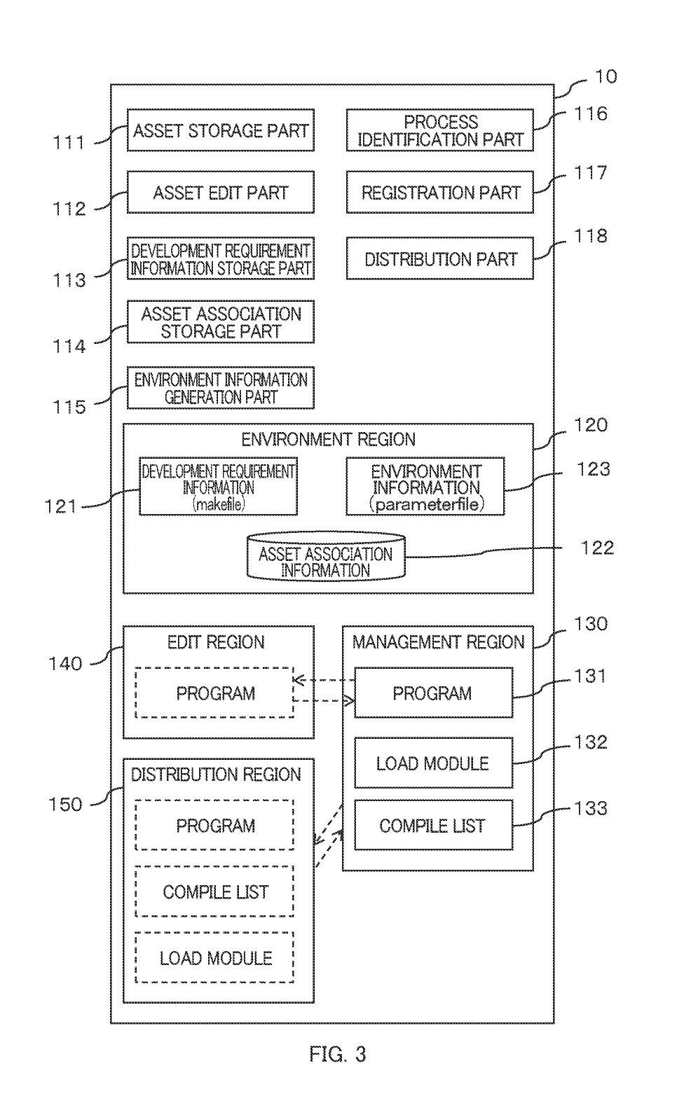

FIG. 3 is a diagram describing an example of functions that the asset management apparatus 10 includes, and storage regions that the asset management apparatus 10 has. As illustrated in FIG. 3, the asset management apparatus 10 includes functions of an asset storage part 111, an asset edit part 112, a development requirement information storage part 113, an asset association storage part 114, an environment information generation part 115, a process identification part 116, a registration part 117, and a distribution part 118. Moreover, the asset management apparatus 10 has a storage region including an environment region 120 that stores therein development requirement information 121, asset association information 122, and environment information 123, a management region 130, an edit region 140, and a distribution region 150.

The asset storage part 111 stores various kinds of information assets in the management region 130. Specifically, the asset storage part 111 stores source code of a program by a language such as COBOL (hereinafter, referred to as a program 131), a load module 132 that is an information asset newly generated from the program 131 by the asset development apparatus 30, and is a module executable in the information processing apparatus, and a compile list 133 that is information generated when the load module 132 is generated and developed.

The asset edit part 112 edits the content of the information assets that are stored in the management region 130 based on a specification from the developer apparatus 20. Specifically, for example, upon reception of the specification from the developer apparatus 20, the asset edit part 112 performs a process of moving (lending) the specified program 131 from the management region 130 to the edit region 140, and editing the program 131 that has been moved to the edit region 140. Further, after the editing of the program 131 is ended, the asset edit part 112 moves (returns) the program 131 after the editing to the management region 130. Further, while the program 131 is lent to the edit region 140, the lent program 131 is set such that apparatuses other than the developer apparatus 20 that has performed the above-mentioned specification cannot edit it

The development requirement information storage part 113 generates the development requirement information 121 (hereinafter, also referred to as a makefile) that is information related to an information asset necessary for generating a new information asset (generation asset) based on the specification by the developer apparatus 20, and stores the development requirement information 121 thus generated in the environment region 120.

The asset association storage part 114 stores the asset association information 122 that is information obtained by associating an information asset with a process of generating a new information asset from the information asset and managing the generated information asset, in the environment region 120.

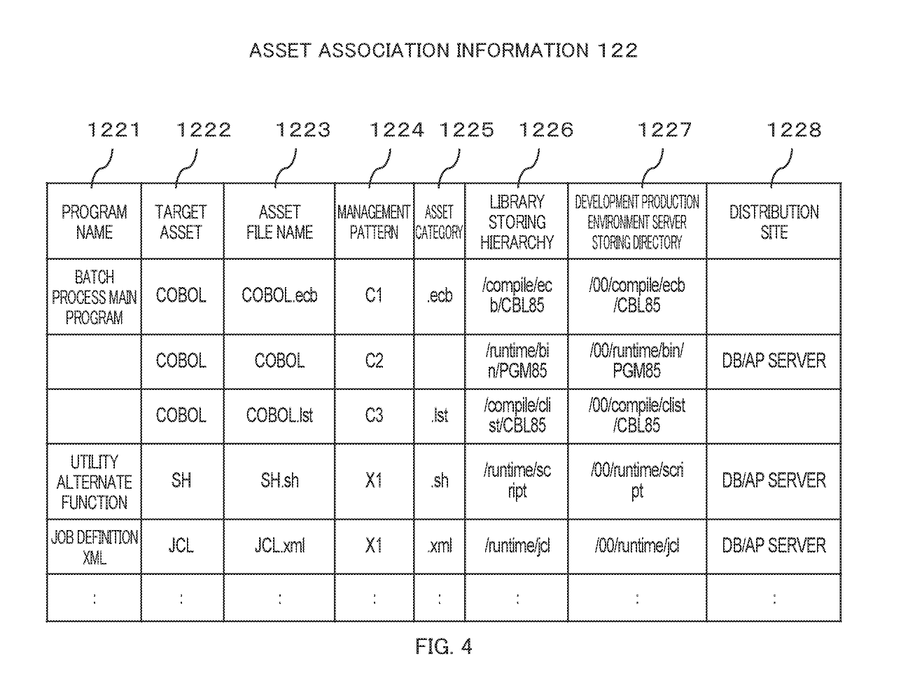

FIG. 4 is a table describing an example of the asset association information 122. In the asset association information 122, information assets are classified into multiple categories, and the category of each of the classified information assets is associated with a process of generating a new information asset from the information asset and managing the new information asset.

As illustrated in FIG. 4, the asset association information 122 is a table (asset association table) that is configured to include at least one record including a program name 1221, a target asset 1222, an asset file name 1223, a management pattern 1224, an asset category 1225, a library storing hierarchy 1226, a development production environment server storing directory 1227, and a distribution site 1228. Each of these items in the asset association information 122 can be corrected/added/deleted as desired, for example, manually or automatically by a manager of the information asset management system 1.

Information indicating a generation asset is stored in the program name 1221. Information identifying the content of an information asset of the program name 1221 is stored in the target asset 1222. Information (for example, a file name) identifying an information asset that is necessary for generating the information asset of the program name 1221 is stored in the asset file name 1223.

Information identifying a process that is executed for the information asset of the asset file name 1223 is stored in the management pattern 1224. Information identifying a category that is allocated to the information asset of the asset file name 1223 is stored in the asset category 1225. For example, the asset category 1225 stores therein information on a category indicating whether the information asset of the asset file name 1223 is a program, a load module, or a compile list. This category is represented by, for example, an extension of the file name stored in the asset file name 1223. For example, an extension of “ecb” represents that the category of an information asset thereof is (source code of) a COBOL program, no extension represents that the category of an information asset thereof is a load module, and an extension of “1st” represents that the category of an information asset thereof is a compile list.

Here, the management pattern 1224 will be described in detail.

The content of a process for generating a new information asset from the information asset of the asset category 1225 and managing the new information asset is stored in the management pattern 1224.

For example, when the category of the asset category 1225 is a program, “C1” can be stored in the management pattern 1224.

The “C1” represents executing a process of moving (lending) an information asset of the category from the management region 130 to the edit region 140, thereafter moving (returning) the lent information asset to the management region 130, copying the returned information asset to the asset development apparatus 30, and further copying an information asset stored in the management region 130 to the distribution region 150.

Moreover, when the category of the asset category 1225 is a load module, for example, “C2” can be stored in the management pattern 1224. The “C2” represents executing a process of moving (lending) an information asset of the category from the management region 130 to the asset development apparatus 30, thereafter moving (returning) the lent information asset to the management region 130, moreover copying an information asset stored in the management region 130 to the distribution region 150, and transmitting (distributing) an information asset stored in the distribution region 150 to the execution apparatus 40.

Moreover, when the category of the asset category 1225 is a compile list, for example, “C3” can be stored in the management pattern 1224. The “C3” represents executing a process of moving (lending) an information asset of the category from the management region 130 to the asset development apparatus 30, thereafter moving (returning) the lent information asset to the management region 130, and moreover copying an information asset stored in the management region 130 to the distribution region 150.

Information identifying a place in the asset management apparatus 10 where an information asset of the asset file name 1223 is managed (stored) is stored (for example, a directory name or a folder name is stored) in the library storing hierarchy 1226. In the present embodiment, information identifying a place of the management region 130 is stored in the library storing hierarchy 1226.

A place where to generate a new information asset or a place where to store the generated new information asset is stored in the development production environment server storing directory 1227. In other words, a place where to generate a new information asset based on the information asset identified by the program name 1221, or a place where to store the generated information asset is stored (for example, a directory name or a folder name is stored) in the development production environment server storing directory 1227. In the present embodiment, a directory name or a folder name in the asset development apparatus 30 or the execution apparatus 40 is stored in the development production environment server storing directory 1227.

A place (information processing apparatus) where to execute the generated information asset is stored in the distribution site 1228. In other words, a place where to execute the information asset generated from the information asset of the asset file name 1223 is stored (for example, an apparatus name is stored) in the distribution site 1228. In the present embodiment, an apparatus name of the execution apparatus 40 is stored.

Next, as illustrated in FIG. 3, the environment information generation part 115 generates, based on the development requirement information 121 and the asset association information 122, the environment information 123 (hereinafter, also referred to as parameterfile) that includes information (hereinafter, referred to as first information) in which an information asset is associated with a place where to generate a new information asset, and information (hereinafter, referred to as second information) in which the information asset is associated with a place where to execute the generated information asset, and stores the generated environment information 123 in the environment region 120.

The process identification part 116 identifies, based on the asset association information 122, a process to be executed for an information asset that is specified by the developer apparatus 20. Specifically, the process identification part 116 identifies, based on the asset association information 122, a process corresponding to a category of the specified information asset.

The process identification part 116 then instructs the asset development apparatus 30 to generate a new information asset from the specified information asset, based on the identified process in the above and the environment information 123.

The registration part 117 registers (stores) the new information asset generated by the asset development apparatus 30. Specifically, for example, the registration part 117 stores the load module 132 and the compile list 133 that are generated by the asset development apparatus 30, in the management region 130.

The distribution part 118 distributes the new information asset registered in the registration part 117, to the execution apparatus 40. Specifically, for example, the distribution part 118 moves (lends) the load module 132 and the compile list 133 that are stored in the management region 130, to the distribution region 150, and transmits the moved load module 132 to the execution apparatus 40. Further, when this transmission is ended, the distribution part 118 moves (returns) the load module 132 and the compile list 133 that have been moved to the distribution region 150, to the management region 130. Moreover, the load module 132 and the compile list 133 that have been moved to the distribution region 150 are set to be inaccessible from information processing apparatuses other than the developer apparatus 20.

The functions described in the foregoing of the asset management apparatus 10 are implemented by the hardware of the asset management apparatus 10, or in such a way that the processor 11 of the asset management apparatus 10 reads out a program stored in the memory 12 or the storage device 13 and executes the program thus read out.

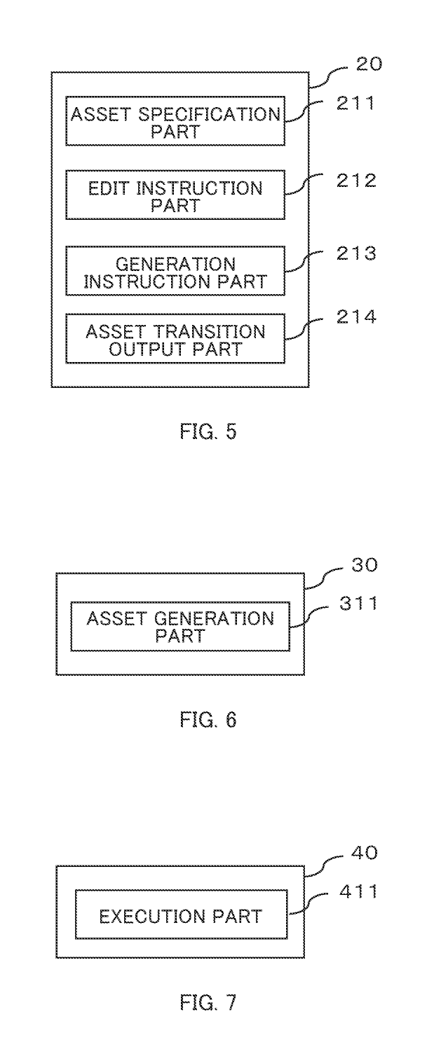

FIG. 5 is a diagram describing an example of functions that the developer apparatus 20 includes. As illustrated in FIG. 5, the developer apparatus 20 includes an asset specification part 211, an edit instruction part 212, and a generation instruction part 213.

The asset specification part 211 specifies an information asset for generating a generation asset for the asset management apparatus 10.

The edit instruction part 212 instructs the asset management apparatus 10 to edit the content of the information asset specified by the asset specification part 211.

The generation instruction part 213 instructs the asset management apparatus 10 to generate a new information asset from the information asset specified by the asset specification part 211 (or the information asset the content of which is edited in accordance with the instruction of the edit instruction part 212).

The functions described in the foregoing of the developer apparatus 20 are implemented by the hardware of the developer apparatus 20, or in such a way that a processor of the developer apparatus 20 reads out a program stored in a memory or a storage device and executes the program thus read out.

FIG. 6 is a diagram describing an example of a function that the asset development apparatus 30 includes. As illustrated in FIG. 6, the asset development apparatus 30 includes an asset generation part 311.

The asset generation part 311 generates a new information asset based on an instruction by the asset management apparatus 10. Specifically, for example, the asset generation part 311 generates the load module 132 and the compile list 133, based on the specified program 131. Further, this function described in the foregoing is implemented by the hardware of the asset development apparatus 30, or in such a way that a processor of the asset development apparatus 30 reads out a program stored in a memory or a storage device and executes the program thus read out.

FIG. 7 is a diagram describing an example of a function that the execution apparatus 40 includes. As illustrated in FIG. 7, the execution apparatus 40 includes an execution part 411.

The execution part 411 executes the new information asset generated by the asset generation part 311 of the asset development apparatus 30. Further, this function described in the foregoing is implemented by the hardware of the execution apparatus 40, or in such a way that a processor of the execution apparatus 40 reads out a program stored in a memory or a storage device and executes the program thus read out.

### Explanation of Process

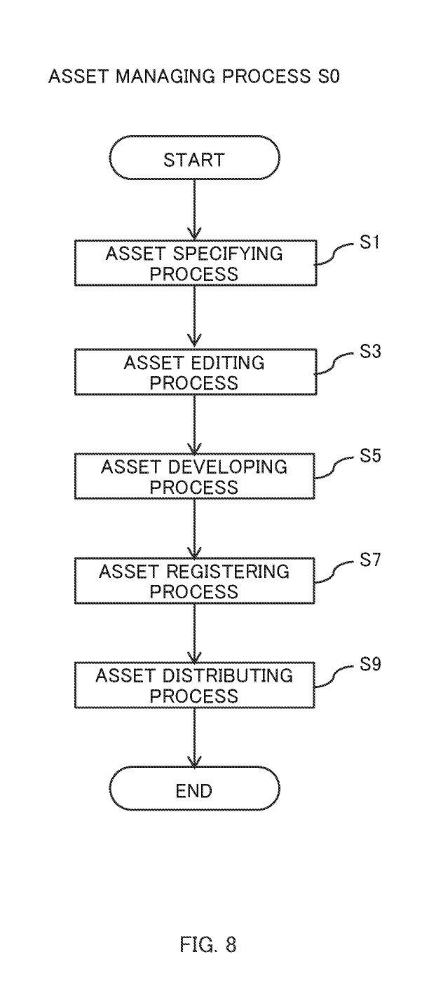

Next, a process to be executed in the information asset management system 1 will be described. FIG. 8 is a flowchart describing a process (hereinafter, referred to as an asset managing process S0), executed in the information asset management system 1, for generating a new information asset (generation asset), based on the information asset that is managed by the asset management apparatus 10. This asset managing process S0 is executed, for example, at a predetermined timing or when the developer or others input a predetermined instruction into the developer apparatus 20.

As illustrated in FIG. 8, the information asset management system 1 firstly executes a process (hereinafter, referred to as an asset specifying process S1) of specifying an information asset necessary for generating a new information asset (S1).

The information asset management system 1 then executes a process (hereinafter, referred to as an asset editing process S3) of editing the information asset specified in S1 (S3).

The information asset management system 1 next executes a process (hereinafter, referred to as an asset developing process S5) of generating and developing a new information asset, based on the information asset edited in S3 (S5). The information asset management system 1 then executes a process (hereinafter, referred to as an asset registering process S7) of registering the newly generated information asset (S7). The information asset management system 1 then executes a process (hereinafter, referred to as an asset distributing process S9) of distributing the registered new information asset (S9).

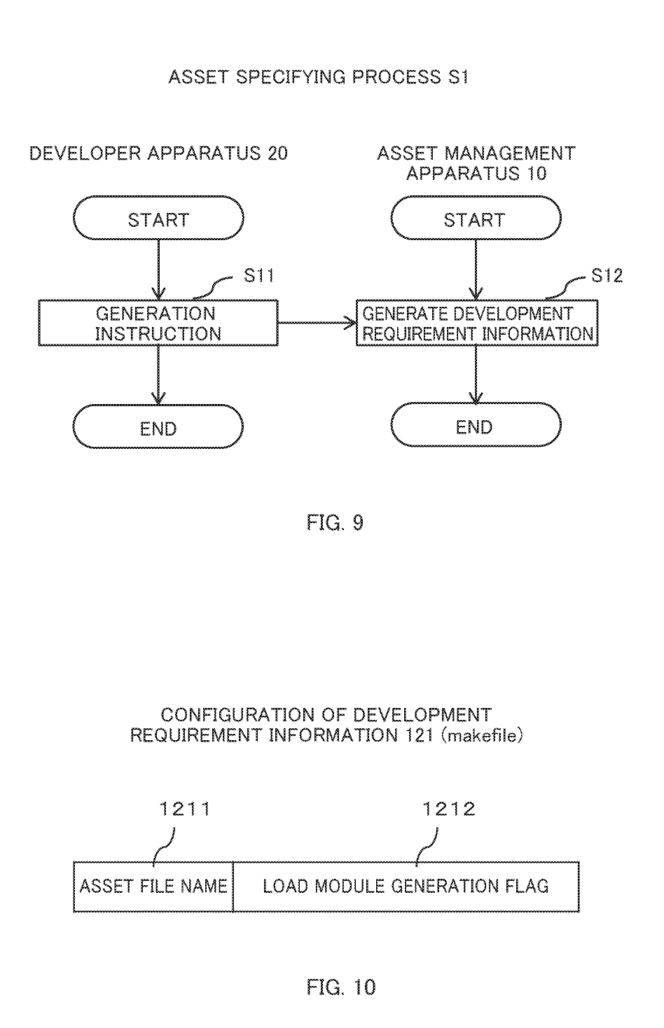

FIG. 9 is a flowchart describing a detail of the asset specifying process S1. As illustrated in FIG. 9, the developer apparatus 20 firstly transmits information instructing that the development requirement information 121 (makefile) is generated, to the asset management apparatus 10 (S11). The asset management apparatus 10 then generates the development requirement information 121 in accordance with this received instruction (S12). Specifically, for example, the developer or others operate an editor that is installed in the developer apparatus 20 to generate the development requirement information 121 in the asset management apparatus 10.

FIG. 10 is a diagram describing an example of a configuration of the development requirement information 121. As illustrated in FIG. 10, the development requirement information 121 is information that includes an asset filename 1211 and a load module generation flag 1212. Information identifying one or more information assets is stored in the asset file name 1211. Information indicating whether the load module 132 is created based on the information asset of the asset file name 1211 is stored in the load module generation flag 1212, and for example, when the load module 132 is created, “P” is specified.

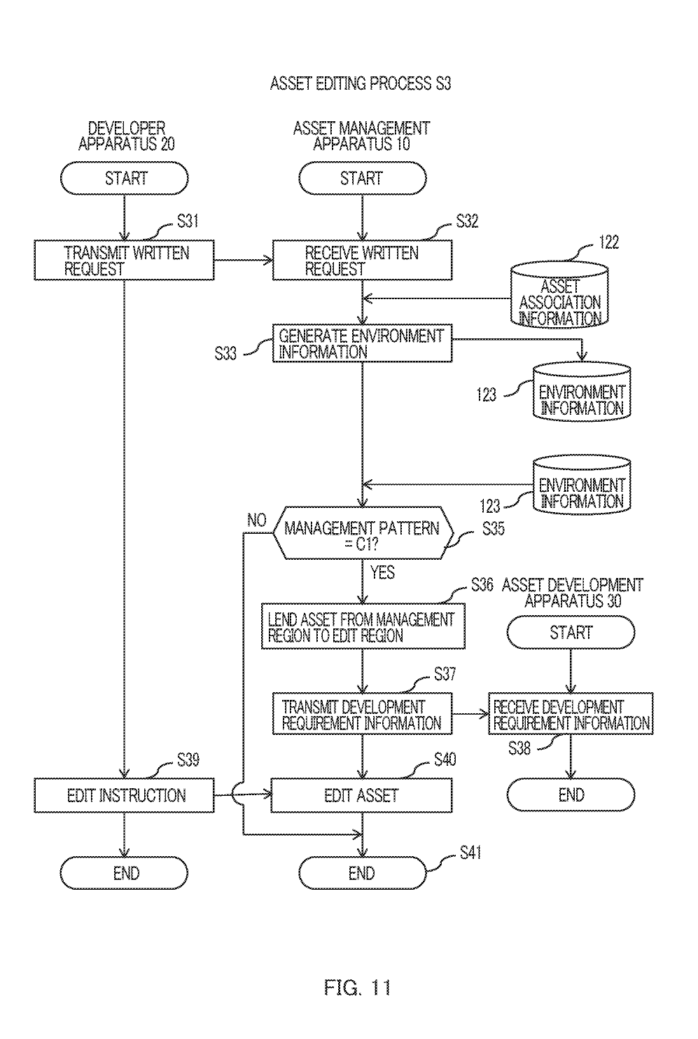

FIG. 11 is a flowchart describing a detail of the asset editing process S3. The asset editing process S3 is started, for example, when a predetermined input operation is made to the developer apparatus 20.

When the asset editing process S3 is started, the developer apparatus 20 firstly generates information (hereinafter, referred to as a written request) indicating that the asset management apparatus 10 is instructed to start a process of the asset editing process S3 with respect to the information asset specified in the development requirement information 121, and transmits the generated written request to the asset management apparatus 10 (S31). Further, this written request is generated, for example, by an input accepting function (an input menu or the like) of the written request that is provided in the developer apparatus 20.

The asset management apparatus 10 receives the written request transmitted by the developer apparatus 20 (S32). It should be noted that an information asset designated by a written request is hereinafter referred to as a specification asset.

The written request is information including, for example, information identifying the development requirement information 121 (makefile) generated in S1 (in other words, information identifying the specification asset), and information distinguishing the written request (for example, configured to include data and a serial number). Further, these pieces of information are specified by, for example, a file name of the written request.

Next, the asset management apparatus 10 generates the environment information 123 (parameterfile) based on the written request and the asset association information 122 (S33). Specifically, the asset management apparatus 10 acquires a record in which a specification asset is stored in the target asset 1222, out of records of the asset association information 122, and generates the environment information 123 based on the acquired record.

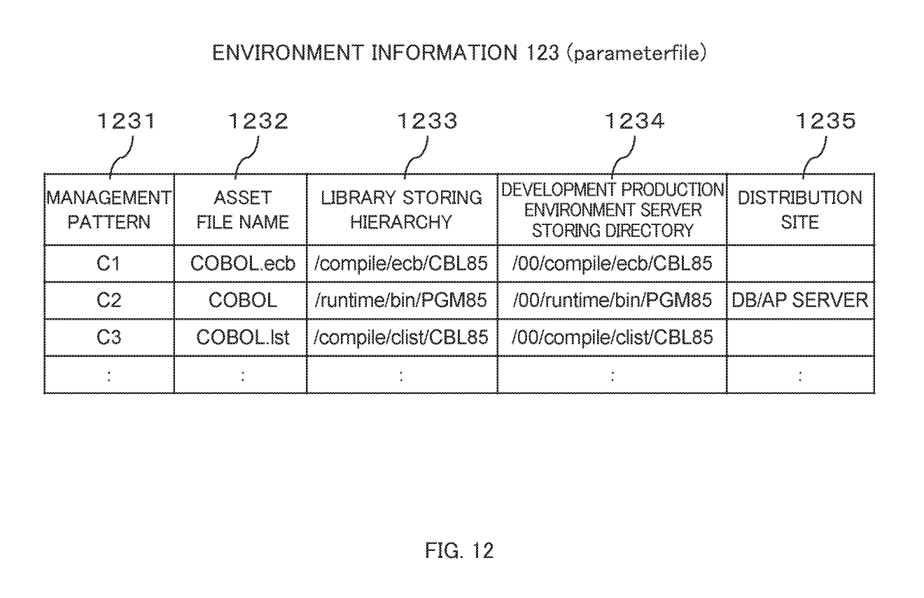

FIG. 12 is a diagram illustrating an example of the environment information 123. As illustrated in FIG. 12, the environment information 123 is a table that is configured to include at least one record including items of a management pattern 1231, an asset file name 1232, a library storing hierarchy 1233, a development production environment server storing directory 1234, and a distribution site 1235.

Information corresponding to the management pattern 1224 is stored in the management pattern 1231. Information corresponding to the asset file name 1223 is stored in the asset filename 1232. Information corresponding to the library storing hierarchy 1226 is stored in the library storing hierarchy 1233. Information corresponding to the development production environment server storing directory 1227 is stored in the development production environment server storing directory 1234. Information corresponding to the distribution site 1228 is stored in the distribution site 1235.

As illustrated in S35 in FIG. 11, the asset management apparatus 10 identifies a management pattern of the specification asset (a process to be executed for the specification asset). Specifically, the asset management apparatus 10 acquires one record in the environment information 123, and refers to the management pattern 1231 of the acquired record.

If the management pattern 1231 is “C1” (S35: YES), the process proceeds to S36, whereas if the management pattern 1231 is not “C1” (S35: NO), the asset management apparatus 10 transmits a notification that the asset editing process S3 is ended to the developer apparatus 20 (which is not illustrated) accordingly to end the asset editing process S3 (S41).

At S36 in FIG. 11, the asset management apparatus 10 lends a specification asset. Specifically, the asset management apparatus 10 moves a specification asset from the management region 130 to the edit region 140. Further, the asset management apparatus 10 herein transmits the development requirement information 121 to the asset development apparatus 30 (S37), and the asset development apparatus 30 receives the development requirement information 121 thus transmitted (S38).

Next, upon receiving an instruction transmitted from the developer apparatus 20 that a specification asset is edited, the asset management apparatus 10 edits the specification asset that has been moved to the edit region 140 at S36 based on the received instruction (S39, S40). Specifically, for example, the developer or others use a function of a text editor that is installed in the developer apparatus 20 to edit the specification asset in the edit region 140.

With that, the asset editing process S3 is ended (S41). It should be noted that when the specification asset includes multiple information assets, the processes from S35 to S40 are repeatedly executed for the information assets (the processes from S35 to S40 are executed for all the records in the environment information 123).

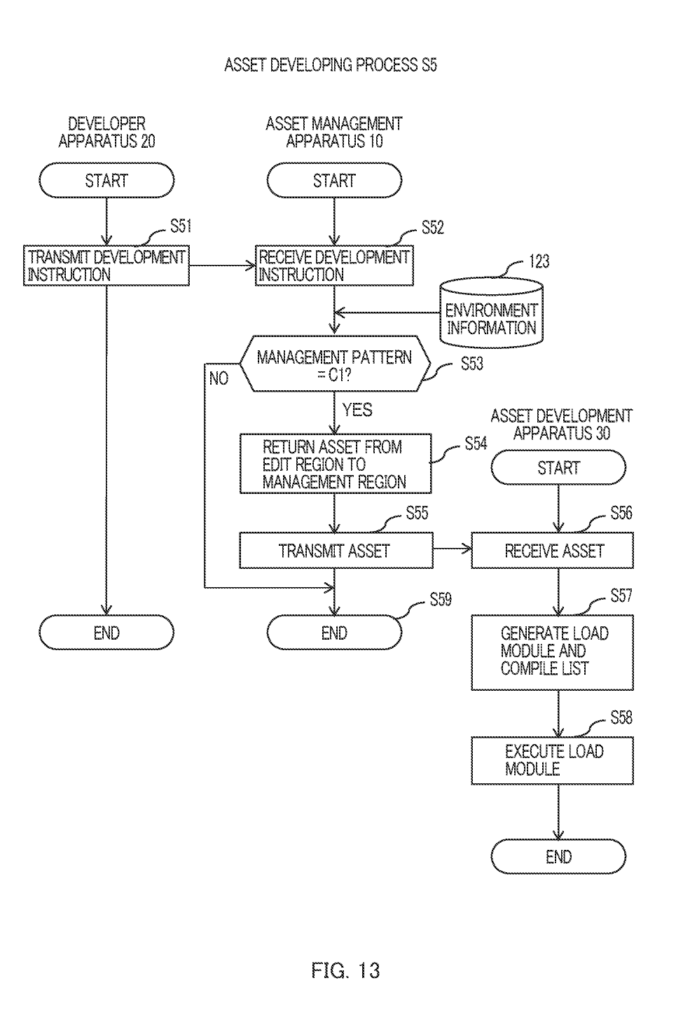

FIG. 13 is a flowchart describing a detail of the asset developing process S5. The asset developing process S5 is started, for example, after the asset editing process S3 is ended, when information (hereinafter, referred to as a first hold release) notifying that the asset developing process S5 is started is inputted into an input device of the developer apparatus 20.

As illustrated in FIG. 13, when the asset developing process S5 is started, the developer apparatus 20 firstly transmits an instruction that a new asset is developed from the specification asset, to the asset management apparatus 10 (S51). Upon receiving this instruction (S52), the asset management apparatus 10 identifies a management pattern of the specification asset (S53). Specifically, the asset management apparatus 10 acquires one record in the environment information 123, and refers to the management pattern 1231 of the acquired record.

If the management pattern 1231 is “C1” (S53: YES), the process proceeds to S54, whereas if the management pattern 1231 is not “C1” (S53: NO), the asset management apparatus 10 transmits a notification that the asset developing process S5 is ended to the developer apparatus 20 (which is not illustrated) accordingly to end the asset developing process S5 (S59). Further, if “P” is not set in the load module generation flag 1212 of the development requirement information 121 that is identified by the written request at S53, the asset management apparatus 10 may transmit a notification that the asset developing process S5 is ended to the developer apparatus 20 (which is not illustrated) accordingly to end the asset developing process S5.

At S54, the asset management apparatus 10 returns the specification asset. Specifically, the asset management apparatus 10 moves the specification asset from the edit region 140 to the management region 130.

Further, the asset management apparatus 10 transmits the returned specification asset to the asset development apparatus 30 (S55).

Upon receiving the specification asset from the asset management apparatus 10 (S56), the asset development apparatus 30 generates a load module and a compile list based on the received specification asset (S57). Specifically, the asset development apparatus 30 performs a process of changing a permission of the received specification asset and a process of changing a line feed code, and compiles the specification asset to which these processes are executed accordingly to generate a load module and a compile list.

Further, the manager or others of the information asset management system 1 may herein execute the generated load module in the asset development apparatus 30 accordingly to perform a test of the load module in a development environment (S58). Further, this process at S58 may be automatically performed.

With that, the asset developing process S5 is ended. It should be noted that when the specification asset includes multiple information assets, the processes from S53 to S58 are repeatedly executed for the information assets (the processes from S53 to S58 are executed for all the records in the environment information 123).

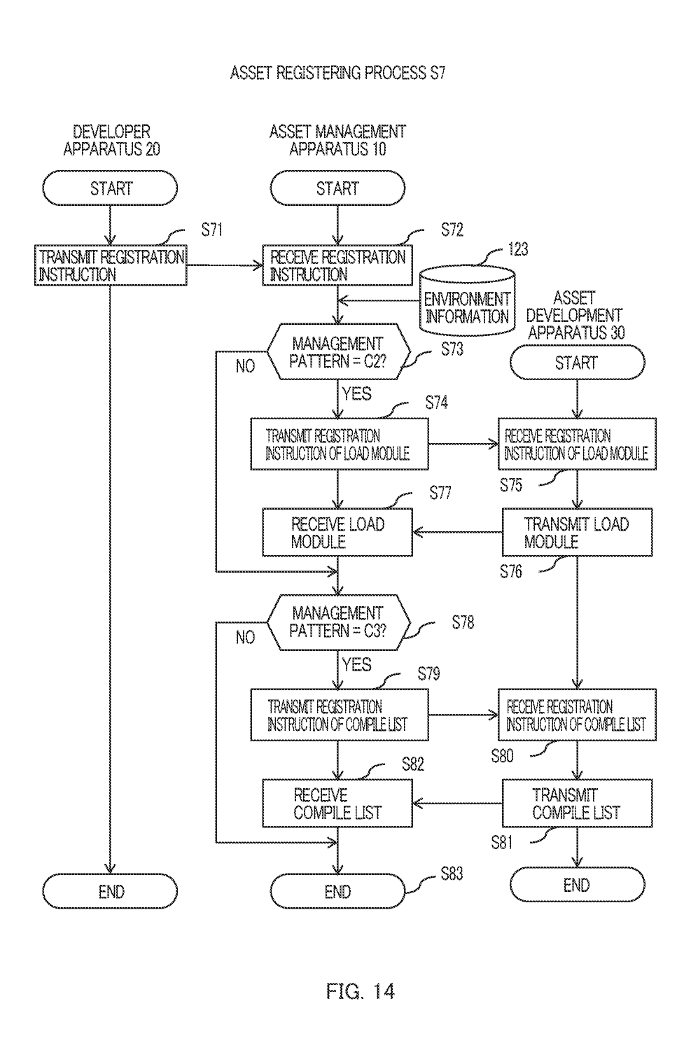

FIG. 14 is a flowchart describing a detail of the asset registering process S7. The asset registering process S7 is started, for example, after the asset developing process S5 is ended, when information (hereinafter, referred to as a second hold release) notifying that the asset registering process S7 is started is inputted into the input device of the developer apparatus 20.

As illustrated in FIG. 14, when the asset registering process S7 is started, the developer apparatus 20 firstly transmits an instruction that the new asset (in the present embodiment, the load module 132 and the compile list 133) that is generated in the asset developing process S5 is registered with the asset management apparatus 10, to the asset management apparatus 10 (S71). Upon receiving this instruction (S72), the asset management apparatus 10 identifies a management pattern of the specification asset (S73). Specifically, the asset management apparatus 10 acquires one record in the environment information 123, and refers to the management pattern 1231 of the acquired record.

If the management pattern 1231 is “C2” (S73: YES), the process proceeds to S74, whereas if the management pattern 1231 is not “C2” (S73: NO), the process proceeds to S78.

At S74, the asset management apparatus 10 transmits an instruction requesting that the load module generated in the asset developing process S5 is registered. Upon receiving this instruction (S75), the asset development apparatus 30 transmits the load module that is generated in the asset developing process S5, to the asset management apparatus 10 (S76), and the asset management apparatus 10 receives this load module (S77) and stores this load module in the management region 130. With this, the load module is registered with the asset management apparatus 10. The process thereafter proceeds to S78.

At S78, the asset management apparatus 10 refers to the management pattern 1231 that is acquired at S73. If the management pattern 1231 is “C3” (S78: YES), the process proceeds to S79, whereas if the management pattern 1231 is not “C3” (S78: NO), the asset management apparatus 10 transmits a notification that the asset registering process S7 is ended, to the developer apparatus 20 (which is not illustrated) accordingly to end the asset registering process S7 (S83).

At S79, the asset management apparatus 10 transmits an instruction that the compile list that is generated in the asset developing process S5 is registered. Upon receiving this instruction (S80), the asset development apparatus 30 transmits the compile list that is generated in the asset developing process S5, to the asset management apparatus 10 (S81), and the asset management apparatus 10 receives this compile list (S82) and stores this compile list in the management region 130. With this, the compile list is registered with the asset management apparatus 10.

With that, the asset registering process S7 is ended (S83). It should be noted that when the specification asset includes multiple information assets, the processes from S73 to S82 are repeatedly executed for the information assets (the processes from S73 to S82 are executed for all the records in the environment information 123).

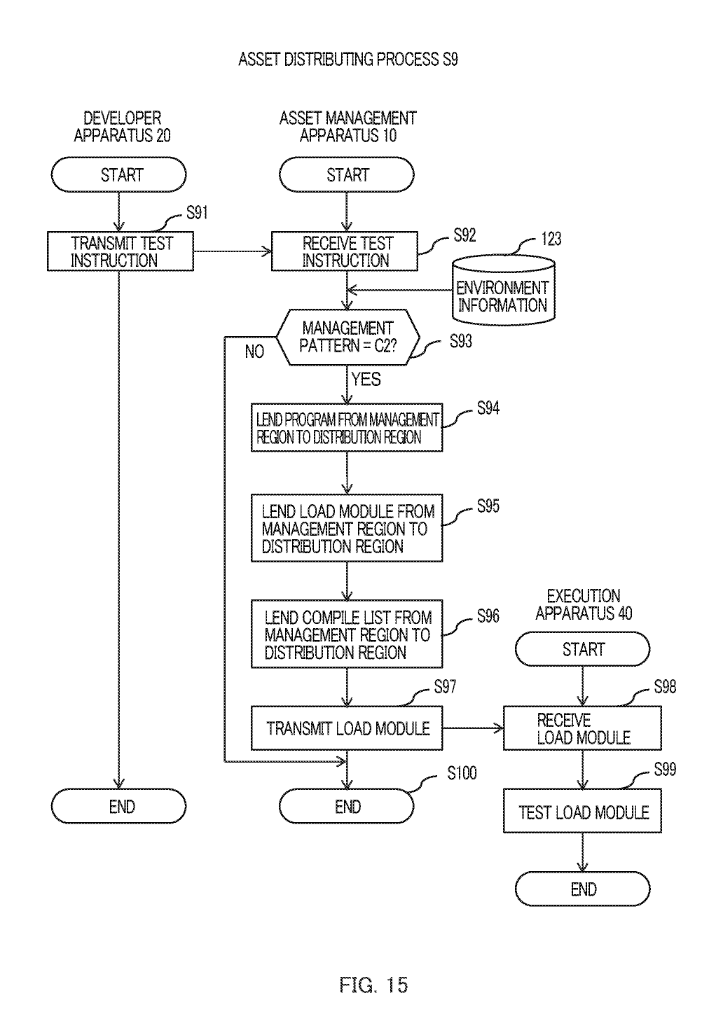

FIG. 15 is a flowchart describing a detail of the asset distributing process S9. The asset distributing process S9 is started, for example, when information (hereinafter, referred to as a third hold release) notifying that the asset distributing process S9 is started is inputted into the input device of the developer apparatus 20.

As illustrated in FIG. 15, when the asset distributing process S9 is started, the developer apparatus 20 firstly transmits an instruction that the new asset registered in the asset registering process S7 is distributed to a distribution destination, to the asset management apparatus 10 (S91). Upon receiving this instruction (S92), the asset management apparatus 10 identifies a management pattern of the specification asset (S93). Specifically, the asset management apparatus 10 acquires one record in the environment information 123, and refers to the management pattern 1231 of the acquired record.

If the management pattern 1231 is “C2” (S93: YES), the process proceeds to S94, whereas if the management pattern 1231 is not “C2” (S93: NO), the asset management apparatus 10 transmits a notification that the asset distributing process S9 is ended to the developer apparatus 20 (which is not illustrated) accordingly to end the asset distributing process S9 (S100).

At S94, the asset management apparatus 10 lends the program 131 registered in the asset registering process S7 to the distribution region 150. Specifically, the asset management apparatus 10 moves the program 131 stored in the management region 130 to the distribution region 150.

Moreover, the asset management apparatus 10 lends the load module 132 registered in the asset registering process S7 to the distribution region 150 (S95). Specifically, the asset management apparatus 10 moves the load module 132 stored in the management region 130 to the distribution region 150.

Moreover, the asset management apparatus 10 lends the compile list 133 registered in the asset registering process S7 to the distribution region 150 (S96). Specifically, the asset management apparatus 10 moves the compile list 133 stored in the management region 130 to the distribution region 150.

Further, the asset management apparatus 10 distributes the load module 132 lent to the distribution region 150 (S97). Specifically, the asset management apparatus 10 identifies a distribution destination (the execution apparatus 40 in the present embodiment) of the record acquired at S93 stored in the distribution site 1235, and transmits the load module 132 lent to the distribution region 150, to the identified distribution destination.

Further, the execution apparatus 40 that is a distribution destination receives the load module 132 that is transmitted from the asset management apparatus 10 (S98). Further, the developer or others or the manager or others of the information asset management system 1 may herein execute the load module 132 that is distributed (transmitted) in the execution apparatus 40 accordingly to perform a test in an execution environment (S99). Further, this process at S99 may be automatically performed. Moreover, if a failure occurs in the execution apparatus 40 when the test in this execution environment is performed, the asset management apparatus 10 may again transmit the load module 132 in the distribution region 150 to the execution apparatus 40.

With that, the asset distributing process S9 is ended (S100). It should be noted that when the specification asset includes multiple information assets, the processes from S93 to S99 are repeatedly executed for the information assets (the processes from S93 to S99 are executed for all the records in the environment information 123).

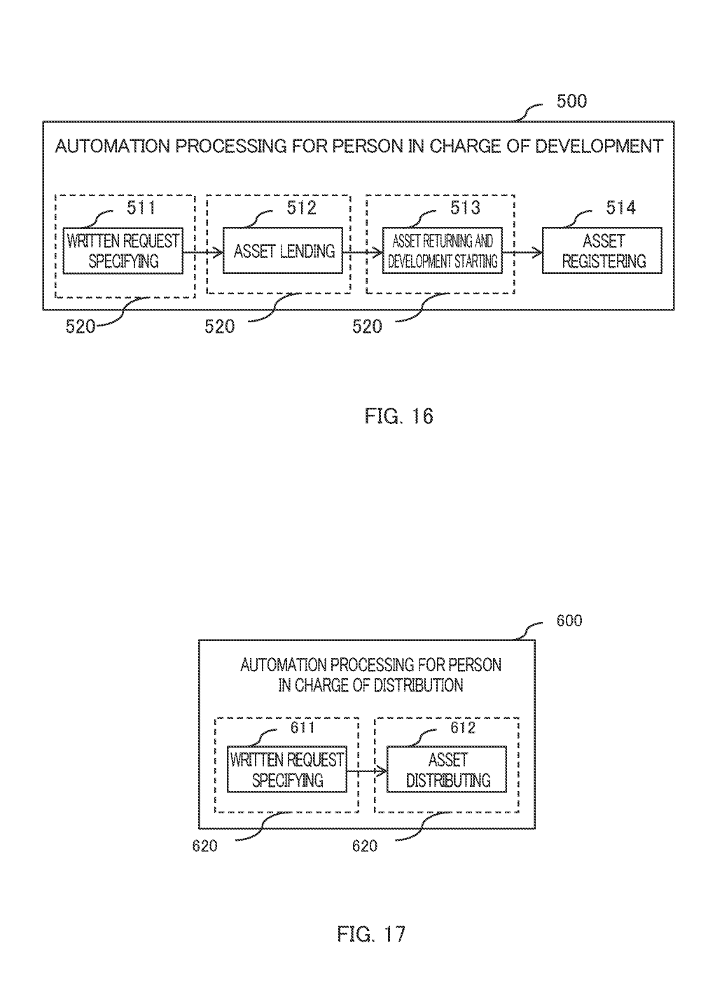

FIG. 16 is a diagram illustrating an example of a screen that is outputted from an asset transition output part 214.

As illustrated in FIG. 16, a screen 500 on which the transition of the processes performed by the information asset management system 1 is displayed in an output device of the developer apparatus 20. In other words, displayed are items of: written request specifying 511 indicating that a written request is transmitted in the asset editing process S3; asset lending 512 indicating that the program 131 is lent from the management region 130 to the edit region 140 based on the written request in the asset editing process S3; asset returning and development starting 513 indicating that the program 131 lent to the edit region 140 is returned to the management region 130, and development (generation of the load module 132) of the returned program 131 is started in the asset developing process S5; and asset registering 514 indicating that the generated load module 132 and the like are registered with the asset management apparatus 10 in the asset registering process S7.

Moreover, when the information asset management system 1 completes a process indicated in each of the abovementioned items, the item corresponding to the process is highlight displayed, color displayed, or displayed in other manners (reference numeral 520).

The screen output as in the foregoing allows the developer or others to easily grasp a development status of the information asset specified based on the written request of the program in real time.

Further, the item of the asset returning and development starting 513 also serves as an interface that transmits the first hold release, so that an input to this item starts to return the program 131 and generate the load module 132, for example. Moreover, the item of the asset registering 514 also serves as an interface that transmits the second hold release, so that an input to this item starts registration of the load module 132 and the like, for example.

FIG. 17 is a diagram illustrating an example of another screen that is outputted from the asset transition output part 214.

As illustrated in FIG. 17, a screen 600 on which a progress of the processes performed by the information asset management system 1 is displayed in an output device of the developer apparatus 20. In other words, displayed are items of; written request specifying 611 indicating that a written request is transmitted in the asset editing process S3; and asset distributing 612 indicating that the load module 132 registered in the asset distributing process S7 is distributed in the asset distributing process S9.

Moreover, when the information asset management system 1 completes a process indicated in each of the above-mentioned items, the item corresponding to the process is highlight displayed, color displayed, or displayed in other manners (reference numeral 620).

Further, the item of the asset distributing 612 also serves as an interface that transmits the third hold release, so that an input to this item starts distribution of the load module 132 and the like, for example.

The screen output as in the foregoing allows those in charge of distribution of the load module 132 to easily grasp a distribution status of the load module 132 that is generated based on the written request of the load module 132 in real time.

Further, the screen 500 and screen 600 may be simultaneously outputted. Moreover, the function of the asset transition output part 214 in the foregoing may be provided in any of the asset management apparatus 10, the developer apparatus 20, the asset development apparatus 30, and the execution apparatus 40.

As described above, the information asset management system 1 in the present embodiment stores therein the asset association information 122 in which an information asset is associated with a process for generating a new information asset from the information asset and managing the new information asset, identifies a process corresponding to a specified information asset based on the asset association information 122, and generates a new information asset from the specified information asset based on the identified process, so that the information asset management system 1 only specifies an information asset used to generate a new information asset to make it possible to easily execute a process corresponding to the specified information asset, and generate the new information asset. This can achieve the automation (labor saving) and the standardization in a development work of an information asset, and reduce a management error and a work error by a worker.

In particular, a situation of a program development in which a load module or the like is generated as a new information asset from source code of a program may easily cause cumbersome works including a version management of the source code of the program, a load module, and the like, debugging, and the like in the development work. However, the information asset management system 1 according to the present embodiment can manage these information assets (the source code of the program, the load module, and the like) with high efficiency and without any error.

Moreover, the information asset management system 1 according to the present embodiment generates the environment information 123 that is information including first information (the asset file name 1232 and the development production environment server storing directory 1234) in which an information asset is associated with a place where to generate a new information asset, and second information (the asset file name 1232, the development production environment server storing directory 1234, and the distribution site 1235) in which the information asset is associated with a place where to execute the generated information asset, generates the new information asset from the specified information asset based on the environment information, and executes the generated information asset. Thus, even if a place where to store the generated information asset or a place where to execute the generated information asset vary among specified information assets, the information asset management system 1 can reliably generate an information asset in the suitable place, and execute the generated information asset in the suitable place. This allows an easy management of the development work of an information asset.

Moreover, in the asset association information 122, information assets are classified into multiple categories, and the category of each of the classified information assets, and a process of generating a new information asset from the information asset and managing the generated information asset are stored in association with each other. The information asset management system 1 identifies a process corresponding to the category of the specified information asset based on the asset association information 122, so that even if information assets of a huge number of categories are managed, and processing methods vary among the categories, the information asset management system 1 can reliably and appropriately generate a new information asset.

The above description of the embodiment is made for easy understanding of the present invention, but does not limit the present invention. The present invention can be modified and improved without departing from the spirit and scope of the invention, and the present invention includes equivalents thereof.

For example, in the present embodiment, the program 131 is employed as an information asset that is designated by the asset management apparatus 10. However, other information assets such as source code of a script such as a shell script, screen data, form data, and document data may be used. Further, a new information asset (generation asset) such as a control program or an integral document that is generated from these information assets may be managed.

Moreover, in the present embodiment, the asset management apparatus 10, the developer apparatus 20, the asset development apparatus 30, and the execution apparatus 40 are provided as different information processing apparatuses. However, a part of or all parts of these information processing apparatuses may be provided as a single information processing apparatus. For example, the asset management apparatus 10 and the asset development apparatus 30 may be provided as a single information processing apparatus.

What is claimed is:

1. An information asset management system including a processor that executes a program, and a memory, and generating a new information asset based on a specified information asset, the information asset management system comprising:
an asset association storage part that stores therein asset association information obtained by associating the information asset with a process of generating a new information asset from the information asset and managing the new information asset;
a process identification part that identifies the process to be executed for the specified information asset based on the asset association information; and
an asset generation part that generates the new information asset from the specified information asset based on the identified process.

2. The information asset management system according to claim 1, further comprising:
an execution part that executes the generated new information asset; and
an environment information generation part that generates environment information based on the asset association information, the environment information including first information in which the information asset is associated with a place where to generate the new information asset, and second information in which the information asset is associated with a place where to execute the generated information asset, wherein
the asset generation part generates the new information asset from the specified information asset based on the identified process and the environment information, and
the execution part executes the generated information asset based on the identified process and the environment information.

3. The information asset management system according to claim 1, wherein:
the asset association storage part classifies information assets into a plurality of categories, and stores the asset association information for each of the classified information assets while associating the category with a process of generating a new information asset from the information asset and managing the new information asset; and
the process identification part identifies the process corresponding to the category of the specified information asset based on the asset association information.

4. The information asset management system according to claim 1, wherein
the information asset is source code of a program,
the new information asset including a load module generated from the source code of the program, and
the information asset management system comprises:
an execution part that executes the generated new information asset; and
an environment information generation part that generates environment information including first information in which the information asset is associated with a place where to store the new information asset, and second information in which the information asset is associated with a place where to execute the generated information asset, wherein
the asset association storage part classifies information assets into a plurality of categories, and stores the asset association information for each of the classified information assets while associating the category with a process of generating a new information asset from the information asset and managing the new information asset, and
the process identification part identifies the process corresponding to the category of the specified information asset based on the asset association information,
the asset generation part generates the new information asset from the specified information asset based on the identified process and the environment information, and
the execution part executes the generated information asset based on the identified process and the environment information.

5. The information asset management system according to claim 1, further comprising:
an asset transition output part that outputs information indicating that the new information asset is generated from the specified information asset, information indicating that the generated information asset is stored, and information indicating that the generated information asset is transmitted to a different information processing apparatus.

6. An information asset management method to be executed by an information processing apparatus including a processor that executes a program, and a memory, generating a new information asset based on a specified information asset, and storing asset association information obtained by associating the information asset with a process of generating a new information asset from the information asset and managing the new information asset, the information asset management method comprising:
receiving information specifying the information asset;
identifying the process to be executed for the specified information asset based on the asset association information; and
generating the new information asset from the specified information asset based on the identified process.

7. A non-transitory computer-readable medium that stores therein a program to be executed by an information processing apparatus including a processor that executes the program, and a memory, generating a new information asset based on a specified information asset, and storing asset association information obtained by associating the information asset with a process of generating a new information asset from the information asset and managing the new information asset, the program causing the information processing apparatus to:
receive information specifying the information asset;
identify the process to be executed for the specified information asset based on the asset association information; and
generate the new information asset from the specified information asset based on the identified process.
